(19) United States
(12) Patent Application Publication
(10) Pub. No.: US 2010/0066982 A1
(43) Pub. Date: Mar. 18, 2010

(54) SMALL-SIZED PROJECTOR WITH HIGH HEAT-DISSIPATING EFFICIENCY

(75) Inventors: YI-PING HSIEH, Tu-Cheng (TW); KAI HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,751

(22) Filed: Dec. 22, 2008

(30) Foreign Application Priority Data
Sep. 12, 2008 (CN) 200810304480.5

(51) Int. Cl. G03B 21/16

(52) U.S. Cl. 353/61

(57) ABSTRACT

The projector includes a housing, a projection lens, an optical engine, a light source module and a heat-dissipating module. The housing includes a bottom wall and a front wall, a rear wall, a first sidewall and a second sidewall. The front wall defines a lens hole and a plurality of first vents, the rear wall and the two sidewalls defines at least one second vent. The projection lens is received in the housing with the magnification end thereof arranged adjacent to the lens hole. The light source module includes a light source and a driving circuit board, the light source is received in the housing, the optical engine optically coupling the light source module and the projection lens. The heat-dissipating module comprising a heat sink disposed on the light source and a fan facing to the heat sink.

### TECHNICAL FIELD

The present disclosure generally relates to projectors and, particularly, to a small-sized projector having high efficiency in heat dissipation.

### BACKGROUND

Projectors typically include a high-power lamp, a heat sink, and a fan. The heat sink is for dissipating excess heat generated by the high-power lamp. The fan is for establishing airflow to take heat out of the projector. The heat sink and fan use up a lot of space, adding substantially to the size of the projectors.

What is needed, therefore, is an projector to overcome the above mentioned problems.

### BRIEF DESCRIPTION OF THE DRAWINGS

FIG. 1 is an isometric view of a projector, according to an exemplary embodiment of the invention.

FIG. 2 is a partially exploded view of the projector of FIG. 1.

### DETAILED DESCRIPTION OF THE EMBODIMENTS

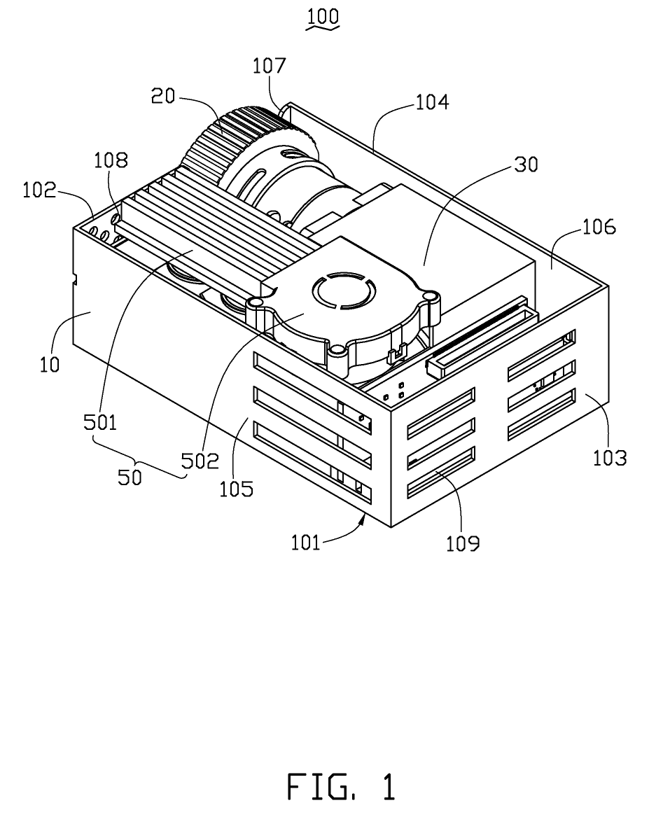

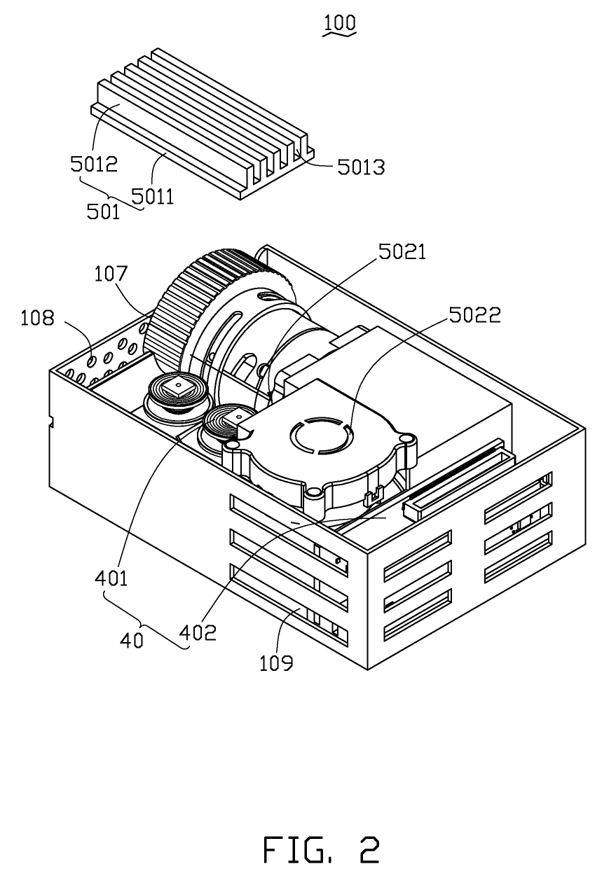

Referring to FIGS. 1 and 2, a projector 100, according to an exemplary embodiment, is shown. The projector includes a housing 10, a projection lens 20, an optical engine 30, a light source module 40, and a heat-dissipating module 50.

The housing 10 includes a bottom wall 101 and a front wall 102, a rear wall 103, a first sidewall 104 and a second sidewall 105. The bottom wall 101, the front wall 102, the rear wall 103 and the two sidewalls 104, 105 together define a receiving space 106. The front wall 102 defines a lens hole 107 adjacent to the first sidewall 104, and a number of first vents 108 near the second sidewall 105, the rear wall 103 and the two sidewalls 104, 105 also define at least one second vent 109. In this embodiment, the first vents 108 are small circular holes, and the second vents 109 are slots.

The projection lens 20 is received in the housing 10 with the magnification end thereof arranged adjacent to the lens hole 201, and is located at an intersecting corner of the front wall 102 and the first sidewall 104, taking up about ¼ of the volume of the receiving space 106.

The light source module 40 includes a light source 401 and a driving circuit board 402. The light source 401 is received in the housing and located at an intersecting corner of the front wall 102 and second sidewall 105, covering about ¼ of the area of the bottom wall 101. However, the height of the light source 401 is less than that of the sidewalls, leaving space for receiving the heat sink 501 (see below). In this embodiment, the light source 401 is a light emitting diode (LED) module, which may comprise of red, green and blue LEDs. The LEDs can be linearly arranged. Also the LEDs can be arranged in other compact arrangements, for example, L-shaped. Alternatively, in other embodiments, the light source 401 can be a metal halide lamp or a xenon lamp.

The driving circuit board 402 is configured for driving the light source 401 to emit light and is electrically connected to the light source 401. The driving circuit board 402 can be directly disposed on the light source 401. However, in this embodiment, the driving circuit board 402 is mounted on the rear wall 103.

The optical engine 30 is also received in the housing 10 and located at an intersecting corner of the first sidewall 104 and the rear wall 103, using up about ¼ of the receiving space 106. The optical engine 30 optically couples the light source 401 to the projection lens 20 and may include one or more of any of condensing lens, reflector, dichromic mirror, spatial light modulator, and color light combiner (not shown), arranged along the path of light generated by the light source 401. The optical engine 30 is configured for modulating the light into optical images and directing the optical images to the minification end of the projection lens 20.

The heat-dissipating module 50 includes a heat sink 501 and a fan 502. The heat sink 501 is configured for dissipating heat generated by the light source 401 and is disposed on the light source 401. The heat sink 501 includes a base 5011 and a number of fins 5012. The base 5011 has a block shape. A bottom surface of the base 5011 is in close contact with the light source 401 to enhance heat-dissipating efficiency of the heat sink 501. The fins 5012 extend upwardly from a upper surface of the base 5011. The fins 5012 are substantially parallel to each other and perpendicular to the upper surface so that a number of air channels 5013 substantially parallel to the first and second sidewalls 104, 105 are defined between the fins 5012. The fan 502 is located at an intersecting corner of the rear wall 103 and the second sidewall 105, which defines an air outlet 5021 facing the heat sink 501 and the air channels 5013 on the upper surface of the base 5011 so that air flow produced by the fan 502 can flow past the air channels 5013 with extremely low air resistance, and an air inlet 5022 defined on the upper surface of the fan 502.

It is proved by our exemplary models that, being so constructed, the components of the projectors 100 are in an extremely compact arrangement. The receiving space 106 is efficiently utilized. Accordingly, the size of the projector 100 is substantially decreased. In addition, the fan 502 establishing airflow through the second vent 109 to the air inlet 5022, to the air outlet 5021, to the air channels 5013, and to the first vents 108 can efficiently remove heat dissipated by the heat sink 501 from the housing 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A projector comprising:
a housing comprising a bottom wall and a front wall, a rear wall, a first sidewall and a second sidewall, the bottom wall, the front wall, the rear wall and the two sidewalls together defining a receiving space, the front wall defining a lens hole and a plurality of first vents, the rear wall and the two sidewalls defining at least one second vent;
a projection lens received in the housing with the magnification end thereof arranged adjacent to the lens hole, and located at an intersecting corner of the front wall and the first sidewall;
an optical engine received in the housing and located at an intersecting corner of the first sidewall and the rear wall; a light source module comprising a light source and a driving circuit board configured for driving the light source to emit light and is electrically connected to the light source, the light source being received in the housing and located at an intersecting corner of the second sidewall and the front wall, the optical engine optically coupling the light source module and the projection lens; and
a heat-dissipating module comprising a heat sink disposed on the light source and a fan located at an intersecting corner of the rear wall and the second sidewall.

2. The projector as claimed in claim 1, wherein the driving circuit board is mounted on the rear wall, the lens hole is adjacent to the first sidewall, the first vents to the second sidewall, the at least one second vent is defined on the rear wall and the two sidewalls.

3. The projector as claimed in claim 2, wherein the first vents are small circular holes, the second vents are slots.

4. The projector as claimed in claim 1, wherein the light source is a light emitting diode (LED) module.

5. The projector as claimed in claim 4, wherein the LED module is consisted of red, green and blue LEDs.

6. The projector as claimed in claim 4, wherein the LEDs are linearly arranged or L-shaped arranged.

7. The projector as claimed in claim 1, wherein the optical engine comprises a set of condensing lenses, reflector, dichromic mirror, spatial light modulator, color light combiner arranged along the path of light generated by the light source and is configured for modulating the light into optical images and directing the optical image to the minification end of the projection lens.

8. The projector as claimed in claim 1, wherein the heat sink comprises a base and a plurality of fins extending upwardly from an upper surface of the base, a bottom surface of the base is in close contact with the light source, the fins are substantially parallel to each other and perpendicular to the upper surface of the base.

9. The projector as claimed in claim 8, wherein a plurality of air channels are defined between the fins.

10. The projector as claimed in claim 8, wherein the fan defines an air outlet facing the heat sink and the air channels on the upper surface of the base, and an air inlet on the upper surface of the fan.
